(19) United States
(12) Patent Application Publication
(10) Pub. No.: US 2025/0228284 A1
(43) Pub. Date: Jul. 17, 2025

(54) CIGARETTE AND DEVICE FOR GENERATING AEROSOL WITH THE SAME

(71) Applicant: KT&G CORPORATION, Daejeon (KR)

(72) Inventor: Jaemin LEE, Siheung-si Gyeonggi-do (KR)

(73) Assignee: KT&G CORPORATION, Daejeon (KR)

(21) Appl. No.: 18/703,275

(22) PCT Filed: Oct. 12, 2022
(86) PCT No.: PCT/KR2022/015425

§ 371 Date: Apr. 19, 2024

(30) Foreign Application Priority Data
Oct. 29, 2021 (KR) 10-2021-0147014
Mar. 2, 2022 (KR) 10-2022-0026723

(51) Int. Cl. A24D 1/20; A24B 15/28; A24D 1/02; A24F 40/10; A24F 40/20; A24F 40/30; A24F 40/42; A24F 40/465

(52) U.S. Cl. CPC A24D 1/20; A24D 1/02; A24F 40/20; A24F 40/465; A24B 15/283; A24F 40/10; A24F 40/30; A24F 40/42

(57) ABSTRACT

A cigarette and an aerosol-generating are disclosed. the aerosol-generating device of the present disclosure, may comprise a cigarette comprising: a tobacco rod containing aerosol generating material; a wrapper surrounding the tobacco rod; and a metal foil surrounding the tobacco rod at an inner side or an outer side of the wrapper at a position corresponding to the tobacco rod, wherein opposite ends of the metal foil are in contact with each other in a circumferential direction to form a closed loop; a body comprising an insertion space configured to accommodate the cigarette of claim 1; and an induction coil disposed around the insertion space and configured to heat the metal foil.

### TECHNICAL FIELD

The present disclosure relates to cigarette and device for generating aerosol with the same.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to prevent discharge or sparks of a heating element.

It is another object of the present disclosure to prevent loss of current during heat generation.

It is another object of the present disclosure to improve the accuracy of temperature control.

It is another object of the present disclosure to maintain the taste or uniformity of the aerosol.

### Solution to Problem

In accordance with an aspect of the present disclosure for accomplishing the above and other objects, it is possible to provide the cigarette comprising a tobacco rod containing aerosol generating material; a wrapper surrounding the tobacco rod; and a metal foil surrounding the tobacco rod at an inner side or an outer side of the wrapper at a position corresponding to the tobacco rod, wherein opposite ends of the metal foil are in contact with each other in a circumferential direction to form a closed loop.

In accordance with another aspect of the present disclosure for accomplishing the above and other objects, it is possible to provide the aerosol-generating device comprising a body comprising an insertion space configured to accommodate the cigarette of claim 1; and an induction coil disposed around the insertion space and configured to heat the metal foil.

### Advantageous Effects of Invention

According to at least one of embodiments of the present disclosure, it is possible to prevent discharge or sparks of a heating element.

According to at least one of embodiments of the present disclosure, it is possible to prevent loss of current during heat generation.

According to at least one of embodiments of the present disclosure, it is possible to improve the accuracy of temperature control.

According to at least one of embodiments of the present disclosure, it is possible to maintain the taste or uniformity of the aerosol.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 12 are views showing examples of an aerosol-generating device according to embodiments of the present disclosure.

### MODE FOR THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

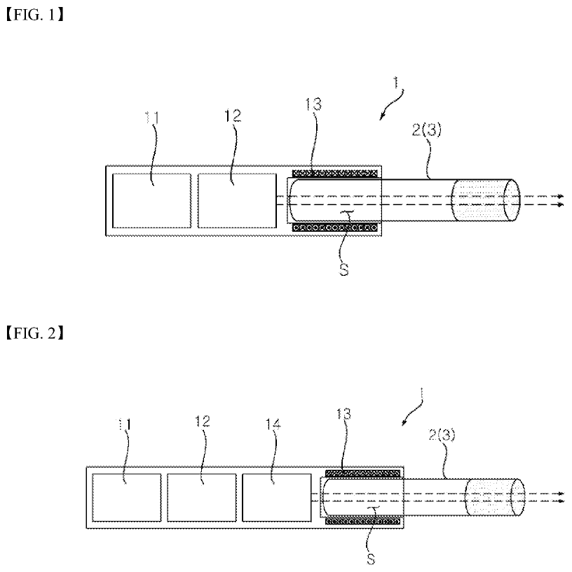

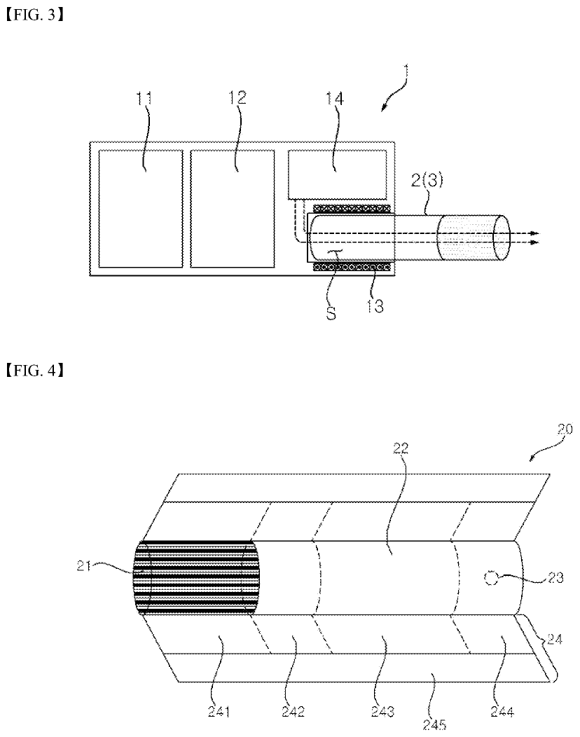

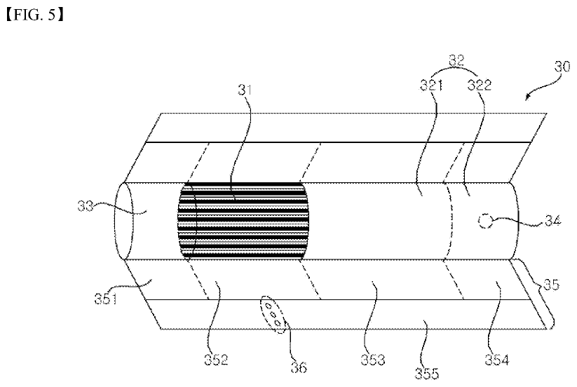

Referring to FIG. 1, the aerosol-generating device 1 may include a battery 11, a control unit 12, and an induction coil 13. Referring to FIGS. 2 and 3, the aerosol-generating device 1 may further include a cartridge 14. An insertion space S may be formed inside the aerosol-generating device 1. the cigarette 2 can be inserted into the insertion space S. The insertion space S may have a cylindrical shape and open to one side.

The aerosol-generating device 1 shown in FIGS. 1 to 3 shows components related to the present embodiment. Therefore, it can be understood by those of ordinary skill in the art related to this embodiment that other general-purpose components other than those shown in FIGS. 1 to 3 may be further included in the aerosol-generating device 1.

Referring to FIG. 1, a battery 11, a controller 12, and an induction coil 13 may be arranged in a line. Referring to FIG. 2, the battery 11, the controller 12, the cartridge 14, and the induction coil 13 may be arranged in a line in vertical direction. Referring to FIG. 3, the cartridge 14 and the induction coil 13 may be arranged in parallel. However, the internal structure of the aerosol-generating device 1 is not limited to those shown in FIGS. 1 to 3. In other words, according to the design of the aerosol-generating device 1, the arrangement of the battery 11, the control unit 12, the induction coil 13 and the cartridge 14 can be changed.

The battery 11 may supply power used to operate the aerosol-generating device 1. For example, the battery 11 may supply electric power so that the induction coil 13 or heater in the cartridge 14 can be heated, and may supply electric power required for the control unit 12 to operate. In addition, the battery 11 may supply power required to operate a display, a sensor, a motor, etc. installed in the aerosol-generating device 1.

The control unit 12 may control the overall operation of the aerosol-generating device 1. Specifically, the control unit 12 may control the operation of the battery 11, the induction coil 13 and the cartridge 14, as well as other components included in the aerosol-generating device 1. Also, the control unit 12 may determine whether the aerosol-generating device 1 is in an operable state by checking the state of each of the components of the aerosol-generating device 1.

The controller 12 may include at least one processor. The processor may be implemented as an array of a plurality of logic gates, or may be implemented as a combination of a general-purpose microprocessor and a memory in which a program executable in the microprocessor is stored. In addition, it can be understood by those of ordinary skill in the art to which this embodiment pertains that it may be implemented in other types of hardware.

The induction coil 13 may receive current from the battery 11. The induction coil 13 may be disposed around the insertion space S. The induction coil 13 may be wound around the insertion space S. The induction coil 13 may generate an eddy current in the conductive metal disposed in the insertion space S, thereby inductively heating the metal.

The cartridge 14 may heat the liquid composition to generate an aerosol, which may be delivered to a user through the cigarette 2. In other words, the aerosol generated by the cartridge 14 may travel along an airflow passage of the aerosol-generating device 1, wherein the airflow passage may be formed so that the aerosol generated by the cartridge 14 passes through the cigarette 2 to the user.

For example, the cartridge 14 may include, but is not limited to, a liquid reservoir, a liquid delivery means, and a heating element. For example, the liquid reservoir, the liquid delivery means and the heating element may be included in the aerosol-generating device 1 as independent modules.

the liquid reservoir may store the liquid composition. For example, the liquid composition may be a liquid comprising a tobacco-containing material comprising a volatile tobacco flavor component, or may be a liquid comprising a non-tobacco material. The liquid reservoir may be manufactured to be detachable from the cartridge 14, or may be manufactured integrally with the cartridge 14.

For example, the liquid composition may include water, a solvent, ethanol, a plant extract, a fragrance, a flavoring agent, or a vitamin mixture. The fragrance may include, but is not limited to, menthol, peppermint, spearmint oil, various fruit flavoring ingredients, and the like. Flavoring agents may include ingredients capable of providing a user with a variety of flavors or flavors. The vitamin mixture may be a mixture of at least one of vitamin A, vitamin B, vitamin C, and vitamin E, but is not limited thereto. Liquid compositions may also include aerosol formers such as glycerin and propylene glycol.

The liquid delivery means may deliver the liquid composition of the liquid reservoir to the heating element. For example, the liquid delivery means may be, but is not limited to, a wick such as cotton fiber, ceramic fiber, glass fiber, or porous ceramic.

The heating element is an element for heating the liquid composition delivered by the liquid delivery means. For example, the heating element may be a metal heating wire, a metal heating plate, a ceramic heater, or the like, but is not limited thereto. In addition, the heating element may be composed of a conductive filament, such as a nichrome wire, and may be arranged in a structure wound around the liquid delivery means. The heating element may be heated by applying an electrical current, and may transfer heat to the liquid composition in contact with the heating element, thereby heating the liquid composition. As a result, an aerosol may be generated.

For example, the cartridge 14 may be referred to as a cartomizer or atomizer, but is not limited thereto.

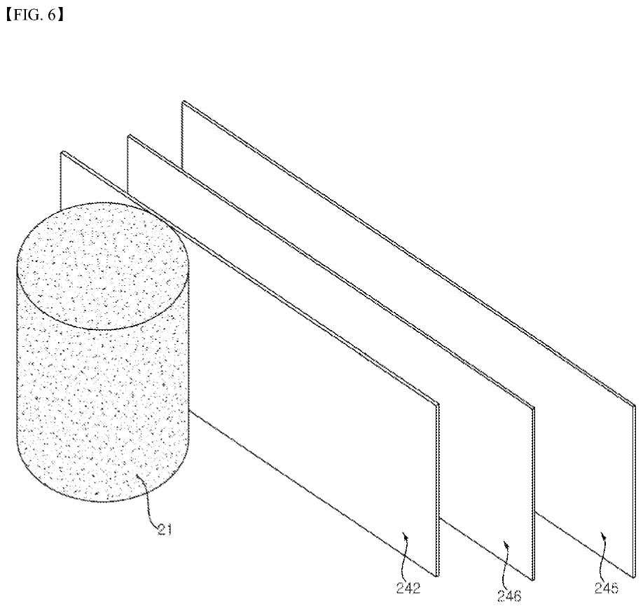

Meanwhile, the aerosol-generating device 1 may further include general-purpose components in addition to the battery 11, the control unit 12, the induction coil 13 and the cartridge 14. For example, the aerosol-generating device 1 may include a display capable of outputting visual information and/or a motor for outputting tactile information. In addition, the aerosol-generating device 1 may include at least one sensor (a puff detection sensor, a temperature sensor, a cigarette insertion detection sensor, etc.). In addition, the aerosol-generating device 1 may be manufactured to have a structure in which external air may be introduced or internal gas may flow out, even in a state in which the cigarette 2 is inserted. The cigarette 2 may include a tobacco rod 21 (see FIG. 4), and a filter rod 22 (see FIG. 4) therein. One side of the cigarette 2 on which the tobacco rod 21 (see FIG. 4) is located is inserted into the insertion space S, the other side of the cigarette 2 may protrude to the outside of the aerosol-generating device 1. The cigarette 2 may further include a metal foil 246 (see FIG. 6) surrounding the tobacco rod 21 (see FIG. 4). When the cigarette 2 is inserted into the insertion space S, the aerosol-generating device 1 may operate the induction coil 13 and/or the cartridge 14 to generate an aerosol. The induction coil 13 may induction heating the metal foil 246 (see FIG. 6). The metal foil 246 (see FIG. 6) may be heated by a magnetic field generated by an AC current flowing through the induction coil 13. The magnetic field may pass through the metal foil 246 (see FIG. 6) to generate an eddy current in the metal foil 246 (see FIG. 6). The current may generate heat in the metal foil 246 (see FIG. 6). The metal foil 246 (see FIG. 6) that is heated by the induction coil 13 may heat the medium such that an aerosol is generated. The aerosol generated by the induction coil 13 and/or the cartridge 14 may pass through the cigarette 2 and be delivered to the user.

The user may inhale the aerosol in the state of biting the other side of the cigarette 100 protruding from the insertion space S to the outside with the mouth. At this time, the aerosol is generated while external air passes through the cigarette 100, and the generated aerosol passes through the other side of the cigarette and is delivered to the user's mouth.

As an example, external air may be introduced through at least one air passage formed in the aerosol-generating device 1. For example, the opening and closing of the air passage and/or the size of the air passage formed in the aerosol-generating device 1 may be adjusted by the user. Accordingly, the amount of atomization, the feeling of smoking, and the like can be adjusted by the user. As another example, outside air may be introduced into the cigarette 2 through at least one hole formed on the surface of the cigarette 2.

Referring to FIG. 4, the cigarette 2 may include a tobacco rod 21 and a filter rod 22. The cigarette 2 may include a tobacco rod 21 on one side and a filter rod 22 on the other side.

Although the filter rod 22 is shown as a single segment in FIG. 4, but is not limited thereto. In other words, the filter rod 22 may be composed of a plurality of segments. For example, the filter rod 22 may include a segment for cooling the aerosol and a segment for filtering a predetermined component contained in the aerosol. In addition, if necessary, the filter rod 22 may further include at least one segment that performs another function.

The diameter of the cigarette 2 is within the range of 5 mm to 9 mm, and the length may be about 48 mm, but is not limited thereto. For example, the length of the tobacco rod 21 is about 12 mm, the length of the first segment of the filter rod 22 is about 10 mm, the length of the second segment of the filter rod 22 is about 14 mm, and the length of the filter rod 22 is about 14 mm. The length of the third segment of may be about 12 mm, but is not limited thereto.

The cigarette 2 may be wrapped by at least one wrapper 24. At least one hole through which external air is introduced or internal gas is discharged may be formed in the wrapper 24. As an example, the cigarette 2 may be wrapped by one wrapper 24. As another example, the cigarette 2 may be wrapped by two or more wrappers 24 overlappingly. For example, the tobacco rod 21 may be packaged by the first wrapper 241, and the filter rod 22 may be packaged by the wrappers 242, 243, and 244. In addition, the entire cigarette 2 may be repackaged by a single wrapper 245. If the filter rod 22 is composed of a plurality of segments, each segment may be wrapped by wrappers 242, 243, and 244.

The first wrapper 241 and the second wrapper 242 may be made of a general filter wrapper. For example, the first wrapper 241 and the second wrapper 242 may be a porous wrapper or a non-porous wrapper. In addition, the first wrapper 241 and the second wrapper 242 may be made of paper and/or aluminum laminate packaging material having oil resistance.

The third wrapper 243 may be made of hard wrapping paper. For example, the basis weight of the third wrapper 243 may be included in the range of 88 g/m²˜96 g/m², preferably in the range of 90 g/m²˜94 g/m². In addition, the thickness of the third wrapper 243 may be included in the range of 120 μm˜130 μm, preferably 125 μm.

The fourth wrapper 244 may be made of an oil-resistant hard wrapper. For example, the basis weight of the fourth wrapper 244 may be included in the range of 88 g/m²˜96 g/m², preferably in the range of 90 g/m²˜94 g/m². In addition, the thickness of the fourth wrapper 244 may be included in the range of 120 μm˜130 μm, preferably 125 μm.

The fifth wrapper 245 may be made of sterile paper (MFW). Here, the sterile paper (MFW) may refer to a paper specially prepared so that tensile strength, water resistance, smoothness, etc. are improved compared to general paper. For example, the basis weight of the fifth wrapper 245 may be included in the range of 57 g/m²˜63 g/m², preferably 60 g/m². In addition, the thickness of the fifth wrapper 245 may be included in the range of 64 μm˜70 μm, preferably 67 μm.

A predetermined material may be internally added to the fifth wrapper 245. Here, an example of the predetermined material may be silicon, but is not limited thereto. For example, silicon has characteristics such as heat resistance with little change with temperature, oxidation resistance without oxidation, resistance to various chemicals, water repellency against water, or electrical insulation. However, even if it is not silicon, any material having the above-described characteristics may be applied (or coated) on the fifth wrapper 245 without limitation.

The fifth wrapper 245 may prevent the cigarette 2 from burning. For example, when the tobacco rod 210 is heated by the heater 13, there is a possibility that the cigarette 2 is burned. Specifically, when the temperature rises above the ignition point of any one of the materials contained in the tobacco rod 310, the cigarette 2 may be burned. Even in this case, since the fifth wrapper 245 includes a non-combustible material, the burning phenomenon of the cigarette 2 can be prevented.

In addition, the fifth wrapper 245 may prevent the holder 1 from being contaminated by substances produced in the cigarette 2. By the user's puff, liquid substances may be created in the cigarette 2. For example, liquid substances (eg, moisture, etc.) may be generated by cooling the aerosol generated in the cigarette 2 by the outside air. As the fifth wrapper 245 wraps the cigarette 2, the liquid substances produced in the cigarette 2 can be prevented from leaking out of the cigarette 2.

Tobacco rod 21 may include an aerosol generating material. The aerosol generating material may be referred to as a medium. For example, the aerosol generating material may include, but is not limited to, at least one of glycerin, propylene glycol, ethylene glycol, dipropylene glycol, diethylene glycol, triethylene glycol, tetraethylene glycol and oleyl alcohol. In addition, the tobacco rod 21 may contain other additive substances such as flavoring agents, wetting agents and/or organic acids. In addition, a flavoring liquid such as menthol or a moisturizing agent may be added to the tobacco rod 21 by being sprayed onto the tobacco rod 21.

Tobacco rod 21 may be manufactured in various ways. For example, the tobacco rod 21 may be manufactured as a sheet or as a strand. In addition, the tobacco rod 21 may be made of cut filler from which the tobacco sheet is chopped. In addition, the tobacco rod 21 may be surrounded by a heat-conducting material. For example, the heat-conducting material may be, but is not limited to, a metal foil such as aluminum foil. For example, the heat-conducting material surrounding the tobacco rod 21 can improve the thermal conductivity applied to the tobacco rod by evenly distributing the heat transferred to the tobacco rod 21, thereby improving the tobacco taste. In addition, the heat-conducting material surrounding the tobacco rod 21 may function as a susceptor heated by an induction heating heater. Although not shown in the drawings, the tobacco rod 21 may further include an additional susceptor in addition to the heat-conducting material surrounding the outside.

The filter rod 22 may be a cellulose acetate filter. On the other hand, the shape of the filter rod 22 is not limited. For example, the filter rod 22 may be a cylindrical type rod, or a tubular type rod including a hollow therein. Also, the filter rod 22 may be a recess type rod. If the filter rod 22 is composed of a plurality of segments, at least one of the plurality of segments may be manufactured in a different shape.

The first segment of the filter rod 22 may be a cellulose acetate filter. For example, the first segment may be a tube-shaped structure including a hollow therein. When the heater 13 is inserted by the first segment, the inner material of the tobacco rod 210 may be prevented from being pushed back, and a cooling effect of the aerosol may be generated. The diameter of the hollow included in the first segment may be an appropriate diameter within the range of 2 mm to 4.5 mm, but is not limited thereto.

The length of the first segment may be an appropriate length within the range of 4 mm to 30 mm, but is not limited thereto. Preferably, the length of the first segment may be 10 mm, but is not limited thereto.

The hardness of the first segment may be adjusted by adjusting the content of the plasticizer in the manufacture of the first segment. In addition, the first segment may be manufactured by inserting a structure such as a film or a tube of the same or different material inside (eg, hollow).

The second segment of the filter rod 22 cools the aerosol generated by the heater 13 heating the tobacco rod 21. Thus, the user can inhale the aerosol cooled to a suitable temperature.

The length or diameter of the second segment may be variously determined according to the shape of the cigarette 2. For example, the length of the second segment may be appropriately applied within the range of 7 mm to 20 mm. Preferably, the length of the second segment may be about 14 mm, but is not limited thereto.

The second segment may be fabricated by weaving polymer fibers. In this case, a fragrance liquid may be applied to the fibers made of the polymer. Alternatively, the second segment may be manufactured by weaving a separate fiber to which the flavoring liquid is applied and a fiber made of a polymer together. Alternatively, the second segment may be formed by a crimped polymer sheet.

For example, the polymer may be made of material selected from the group consisting of polyethylene (PE), polypropylene (PP), polyvinyl chloride (PVC), polyethylene terephthalate (PET), polylactic acid (PLA), cellulose acetate (CA) and aluminum foil.

As the second segment is formed by a woven polymer fiber or crimped polymer sheet, the second segment may include a single or a plurality of channels extending in the longitudinal direction. Here, the channel may mean a passage through which a gas (eg, air or aerosol) passes.

For example, the second segment of the crimped polymer sheet may be formed from a material having a thickness of between about 5 μm and about 300 μm, such as between about 10 μm and about 250 μm. Also, the total surface area of the second segment may be between about 300 mm²/mm and about 1000 mm²/mm. Further, the aerosol cooling element may be formed from a material having a specific surface area of between about 10 mm²/mg and about 100 mm²/mg.

Meanwhile, the second segment may include a thread containing a volatile flavor ingredient. Here, the volatile flavor component may be menthol, but is not limited thereto. For example, the thread may be filled with a sufficient amount of menthol to provide at least 1.5 mg of menthol to the second segment.

The third segment of the filter rod 22 may be a cellulose acetate filter. The length of the third segment may be appropriately employed within the range of 4 mm to 20 mm. For example, the length of the third segment may be about 12 mm, but is not limited thereto.

In the process of manufacturing the third segment, it may be manufactured so that flavor is generated by spraying a flavoring liquid on the third segment. Alternatively, a separate fiber coated with a flavoring liquid may be inserted into the third segment. The aerosol generated by the tobacco rod 21 is cooled as it passes through the second segment of the filter rod 22, and the cooled aerosol is delivered to the user through the third segment. Accordingly, when a flavoring element is added to the third segment, an effect of enhancing the durability of the flavor delivered to the user may occur.

In addition, the filter rod 22 may include at least one capsule 23. Here, the capsule 23 may perform a function of generating flavor, or may perform a function of generating an aerosol. For example, the capsule 23 may have a structure in which a liquid containing a fragrance is wrapped with a film. The capsule 23 may have a spherical or cylindrical shape, but is not limited thereto.

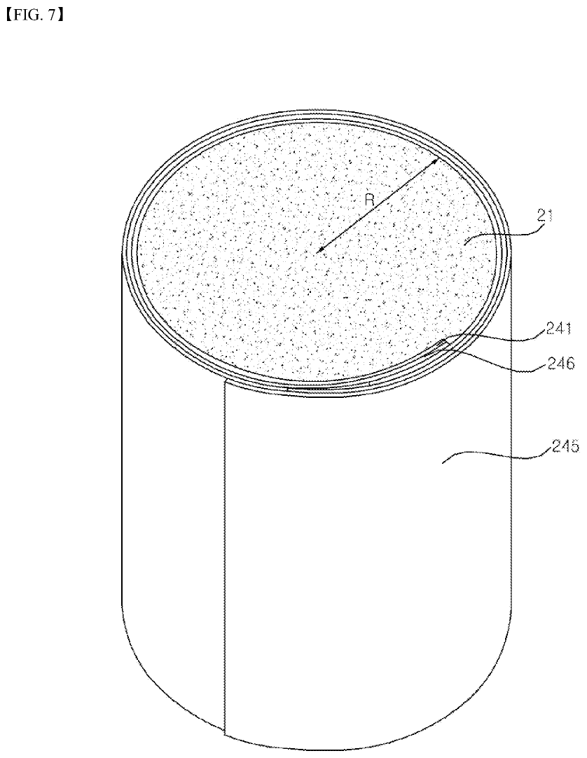

Referring to FIG. 5, the cigarette 3 may further include a front plug 33. The front plug 33 may be located on one side of the tobacco rod 31 opposite to the filter rod 32. The front plug 33 can prevent the tobacco rod 31 from escaping to the outside. The front plug can prevent the aerosol liquefied from the tobacco rod 31 during smoking from flowing into the aerosol-generating device 1 (see FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and overall length of the cigarette 3 may correspond to the diameter and overall length of the cigarette 2 of FIG. 4. For example, the length of the front plug 33 is about 7 mm, the length of the tobacco rod 31 is about 15 mm, the length of the first segment 321 is about 12 mm, the length of the second segment 322 is about 14 mm. However, the present invention is not limited thereto.

The cigarette 3 may be wrapped by at least one wrapper 35. At least one hole through which external air flows or internal gas flows may be formed in the wrapper 35. For example, the front plug 33 is packaged by the first wrapper 351, the tobacco rod 31 is packaged by the second wrapper 352, and the first segment 321 may be wrapped, and the second segment 322 may be wrapped by the fourth wrapper 354. In addition, the entire cigarette 3 may be repackaged by the fifth wrapper 355.

In addition, at least one perforation 36 may be formed in the fifth wrapper 355. For example, the perforation 36 may be formed in the area surrounding the tobacco rod 31, but is not limited thereto. The perforation 36 may serve to transfer the heat formed by the heater 13 shown in FIGS. 2 and 3 to the inside of the tobacco rod 31.

Also, the second segment 322 may include at least one capsule 34. Here, the capsule 34 may perform a function of generating flavor or may perform a function of generating an aerosol. For example, the capsule 34 may have a structure in which a liquid containing fragrance is wrapped with a film. The capsule 34 may have a spherical or cylindrical shape, but is not limited thereto.

The first wrapper 351 may be a general filter wrapper in which a metal foil such as aluminum foil is combined. For example, the total thickness of the first wrapper 351 may be included in the range of 45 μm˜55 μm, preferably 50.3 μm. In addition, the thickness of the metal foil of the first wrapper 351 may be included in the range of 6 μm˜7 μm, preferably 6.3 μm. In addition, the basis weight of the first wrapper 351 may be included in the range of 50 g/m²˜55 g/m², preferably 53 g/m².

The second wrapper 352 and the third wrapper 353 may be made of a general filter wrapper. For example, the second wrapper 352 and the third wrapper 353 may be a porous wrapper or a non-porous wrapper.

For example, the porosity of the second wrapper 352 may be 35000 CU, but is not limited thereto. In addition, the thickness of the second wrapper 352 may be included in the range of 70 μm˜80 μm, preferably 78 μm. In addition, the basis weight of the second wrapper 352 may be included in the range of 20 g/m² to 25 g/m², preferably 23.5 g/m².

For example, the porosity of the third wrapper 353 may be 24000 CU, but is not limited thereto. In addition, the thickness of the third wrapper 353 may be included in the range of 60 μm˜70 μm, preferably 68 μm. In addition, the basis weight of the third wrapper 353 may be included in the range of 20 g/m² to 25 g/m², preferably 21 g/m².

The fourth wrapper 354 may be made of PLA laminated paper. Here, the PLA laminate may refer to a paper layer, a three-ply paper comprising a PLA layer and a paper layer. For example, the thickness of the fourth wrapper 354 may be included in the range of 100 μm˜ 120 μm, preferably 110 μm. In addition, the basis weight of the fourth wrapper 354 may be included in the range of 80 g/m²˜100 g/m², preferably 88 g/m².

The fifth wrapper 355 may be made of sterile paper (MFW). Here, the sterile paper (MFW) may refer to a paper specially prepared so that tensile strength, water resistance, smoothness, etc. are improved compared to general paper. For example, the basis weight of the fifth wrapper 355 may be included in the range of 57 g/m² to 63 g/m², preferably 60 g/m². In addition, the thickness of the fifth wrapper 355 may be included in the range of 64 μm˜70 μm, preferably 67 μm.

A predetermined material may be internally added to the fifth wrapper 355. Here, an example of the predetermined material may be silicon, but is not limited thereto. For example, silicon has characteristics such as heat resistance with little change with temperature, oxidation resistance without oxidation, resistance to various chemicals, water repellency against water, or electrical insulation. However, even if it is not silicon, any material having the above-described characteristics may be applied (or coated) on the fifth wrapper 355 without limitation.

The front plug 33 may be made of cellulose acetate. As an example, the front plug 33 may be manufactured by adding a plasticizer (eg, triacetin) to the cellulose acetate tow. Mono denier of the filament constituting the cellulose acetate tow may be included in the range of 1.0 to 10.0, preferably it may be included in the range of 4.0 to 6.0. More preferably, the mono denier of the filament of the front plug 33 may be 5.0. In addition, the cross section of the filament constituting the front plug 33 may be a Y-shape. The total denier of the front plug 33 may be included in the range of 20000˜30000, preferably may be included in the range of 25000˜30000. More preferably, the total denier of the front end plug 33 may be 28000.

In addition, if necessary, the front plug 33 may include at least one channel, and the cross-sectional shape of the channel may be manufactured in various ways.

The tobacco rod 31 may correspond to the tobacco rod 21 described above with reference to FIG. 4. Therefore, a detailed description of the tobacco rod 31 may be omitted below.

The first segment 321 may be made of cellulose acetate. For example, the first segment may be a tube-shaped structure including a hollow therein. The first segment 321 may be manufactured by adding a plasticizer (eg, triacetin) to the cellulose acetate tow. For example, the mono denier and total denier of the first segment 321 may be the same as the mono denier and total denier of the front plug 33.

The second segment 322 may be made of cellulose acetate. The mono denier of the filaments constituting the second segment 322 may be included in the range of 1.0˜10.0, preferably may be included in the range of 8.0˜10.0. More preferably, the mono denier of the filaments of the second segment 322 may be 9.0. In addition, the cross-section of the filament of the second segment 322 may be Y-shaped. The total denier of the second segment 322 may be included in the range of 20000 to 30000, preferably 25000.

Referring to FIGS. 6 and 7, only the portion corresponding to the tobacco rod 21 of the cigarette 2 is cut, showing that the tobacco rod 21 is wrapped. Hereinafter, the cigarette 2 of FIG. 4 will be described as an example, but it will be clearly understood by those skilled in the art that the description can be applied even when wrapping other tobacco rods, such as the tobacco rod 31 of the cigarette 3 of FIG. 5, etc.

The first wrapper 241 may wrap the outside of the tobacco rod 21. Tobacco rod 21 surrounded by the first wrapper 241 may be formed in a cylindrical shape having an approximately predetermined radius R. The first wrapper 241 may extend long in the circumferential direction along the outer circumferential surface of the tobacco rod 21.

Referring to FIG. 4, the metal foil 246 may be formed in a portion corresponding to the tobacco rod 21. The metal foil 246 may extend along the circumference of the first wrapper 241. The metal foil 246 may surround the outer circumference of the first wrapper 241. As another example, the metal foil 246 may surround the inner circumference of the first wrapper 241 (see FIGS. 12 and 13). The metal foil 246 may be adhered to an outer circumferential surface or an inner circumferential surface of the first wrapper 241. Alternatively, the metal foil 246 and the first wrapper 241 may be formed of paper.

The metal foil 246 may form a closed loop by contacting one side and the other side with respect to the circumferential direction of the metal foil 246. The metal foil 246 may have conductivity and a predetermined resistance. The metal foil 246 may be heated by an eddy current generated by the induction coil 13 (see FIGS. 1 to 3). For example, the metal foil 246 may be an aluminum foil. However, the present invention is not limited thereto.

The fifth wrapper 245 may form the exterior of the cigarette 2. The fifth wrapper 245 may be wrapped around the outer circumferential surface of the first wrapper 241 and/or the metal foil 246. In the circumferential direction, the inner circumferential surface of one side of the fifth wrapper 245 and the outer circumferential surface of the other side of fifth wrapper 245 may be adhered. The fifth wrapper 245 may protect the cigarette 2 from the outside. The fifth wrapper 245 may be referred to as an outer wrapper 245. A portion corresponding to the tobacco rod 21 is formed of a three-ply, and the other portion may be formed of a two-ply.

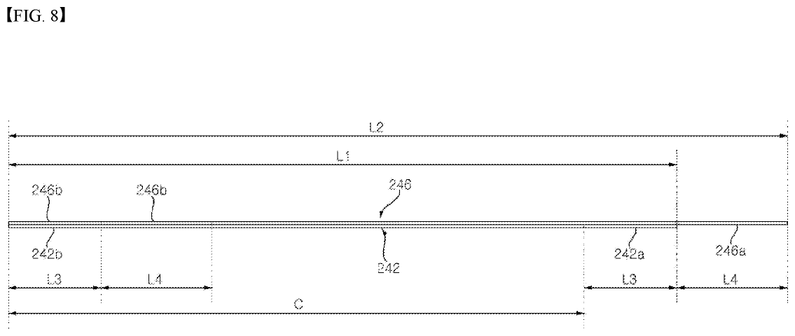

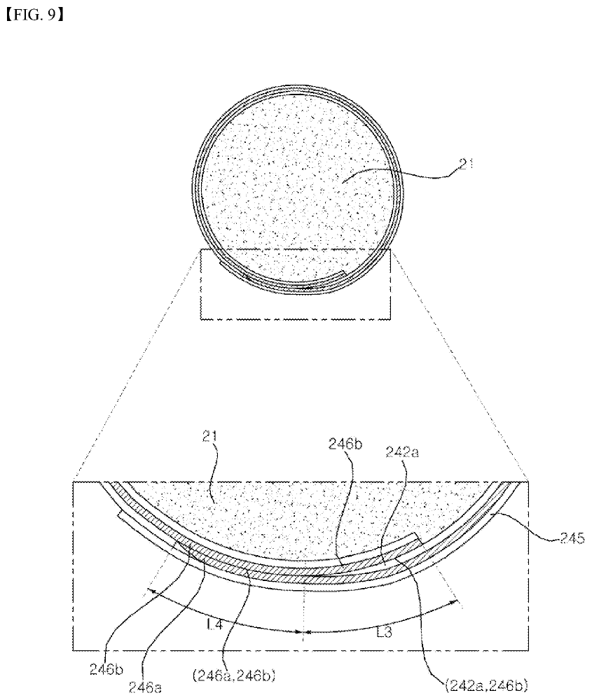

Referring to FIG. 8, the first wrapper 242 may extend by a predetermined length L1 to one side. The metal foil 246 may extend as long as a predetermined length L2 to one side. The length L2 of the metal foil 246 may be greater than the length L1 of the first wrapper 242. One surface of the first wrapper 242 and the other surface of the metal foil 246 may be in contact with or adhered to each other.

The end of one side 246a of the metal foil 246 (hereinafter, one end of the metal foil 246) may be extended by a predetermined length L4 from the end of the one side 242a of the first wrapper 242 (hereinafter, one end of the first wrapper 242) to one side. The one end of the metal foil 246 may be referred to first end of the metal foil 246. The one end of the first wrapper 242 may be referred to first end of the first wrapper 242. In the state of FIG. 8 in which the metal foil 246 and the first wrapper 242 do not wrap the tobacco rod 21, one side 246a of the metal foil 246 may be not overlapped with the first wrapper 242 and protrude to one side. The other side 246b of the metal foil 246 may overlap the other side 242b of the first wrapper 242. The other end of the metal foil 246 and the other end of the first wrapper 242 may coincide. The other end of the metal foil 246 may be referred to second end of the metal foil 246. The other end of the first wrapper 242 may be referred to second end of the first wrapper 242.

Referring to FIGS. 8 and 9, the first wrapper 242 may surround the tobacco rod 21. The metal foil 246 may surround the first wrapper 242 at an outer side of the first wrapper 242. Based on the circumferential direction, one end of the metal foil 246 may extend to one side from the end of the first wrapper 242 and protrude.

The inner circumferential surface of one side 242a of the first wrapper 242 may be in contact with or adhered to the outer circumferential surface of the other side 246b of the metal foil 246. One side 242a of the first wrapper 242 and the other side 246b of the metal foil 246 may overlap by a predetermined length L3.

The inner circumferential surface of one side 246a of the metal foil 246 may be in contact with or adhered to the outer circumferential surface of the other side 246b of the metal foil 246. One side 246a and the other side 246b of the metal foil 246 may overlap by a predetermined length L4 each other. One side 246a and the other side 246b of the metal foil 246 may be connected to each other.

In summary, the outer circumferential surface of the other side 246b of the metal foil 246 may be in contact with the inner circumferential surface of one side 242a of the first wrapper 242 and the inner circumferential surface of one end 242a of the metal foil 246 protruding from one end of the first wrapper 242. The metal foil 246 may form a closed loop. The outer wrapper 245 may surround the outer circumferential surface of the metal foil 246. One side and the other side of the outer wrapper 245 may be adhered each other.

Accordingly, there may be the following advantages over the case in which the metal foil 246 is an open loop. First, it is possible to prevent discharge or sparks that may occur when the induction coil 13 generates an eddy current in the metal foil 246 to heat the metal foil 246. In addition, when the induction coil 13 heats the metal foil 246, it is possible to prevent loss of current. In addition, by reducing the heat generation temperature error of the metal foil 246, the control accuracy is improved, it is possible to maintain the uniformity of the amount or taste of the aerosol.

The circumference of the tobacco rod 21 may be approximately equal to or similar to a length C obtained by subtracting the length L3 of the overlapping portion from the length L1 of the first wrapper 242. That is, if the radius of the tobacco rod 21 is R (refer to FIG. 7), 2 πR which are the circumferences of the tobacco rod 21 and C, may be approximately the same or similar.

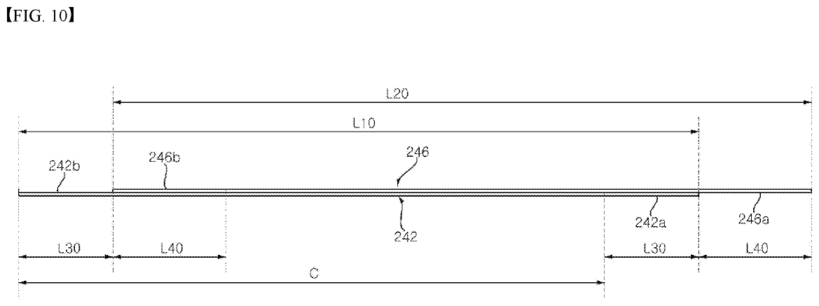

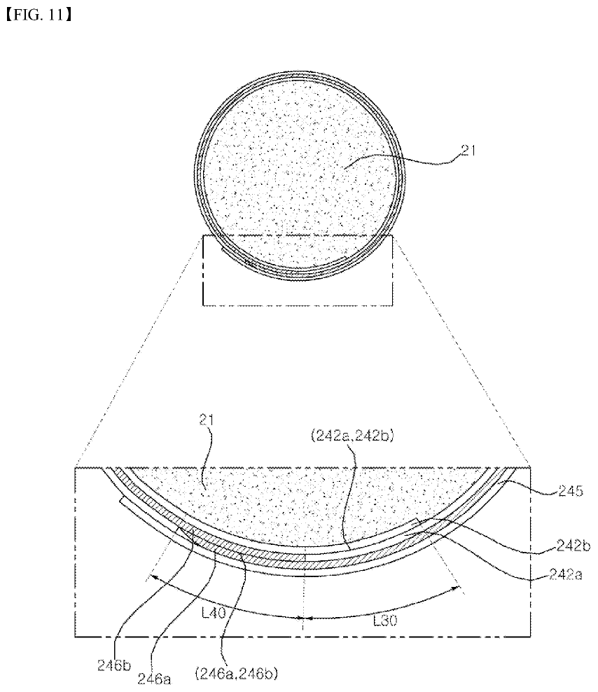

Referring to FIG. 10, the first wrapper 242 may extend by a predetermined length L10 to one side. The metal foil 246 may extend as long as a predetermined length L20 to one side. The length L20 of the metal foil 246 may be greater than the length L10 of the first wrapper 242. One surface of the first wrapper 242 and the other surface of the metal foil 246 may be in contact with or adhered to each other.

One end of the metal foil 246 may extend from one end of the first wrapper 242 to one side by a predetermined length L40. In the state of FIG. 10 in which the metal foil 246 and the first wrapper 242 do not wrap the tobacco rod 21, one side 246a of the metal foil 246 is not overlapped with the first wrapper 242 and is projected to one side. can

The end of the other side 242b of the first wrapper 242 (hereinafter, the other end of the first wrapper 242) may extend from the end of the other side 246b of the metal foil 246 (hereinafter, the other end of the metal foil 246) to the other side by a predetermined length L30. In the state of FIG. 10 in which the metal foil 246 and the first wrapper 242 do not wrap the tobacco rod 21, the other side 242b of the first wrapper 242 may be not overlapped the metal foil 246 and protrude to the other side.

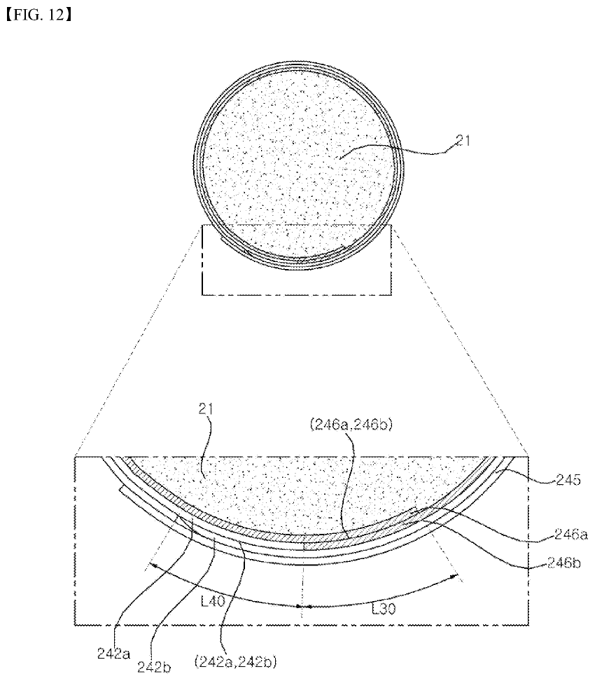

Referring to FIGS. 10 and 11, the first wrapper 242 may surround the tobacco rod 21. The metal foil 246 may surround the first wrapper 242 at an outer side of the first wrapper 242. Based on the circumferential direction, one end of the metal foil 246 may extend to one side from the end of the first wrapper 242 and protrude. Based on the circumferential direction, the other end of the first wrapper 242 may extend from the other end of the metal foil 246 to the other side.

The inner circumferential surface of one side 242a of the first wrapper 242 may be in contact with or adhered to the outer circumferential surface of the other side 242b of the first wrapper 242. One side 242a and the other side 242b of the first wrapper 242 may overlap by a predetermined length L30.

The inner circumferential surface of one side 246a of the metal foil 246 may be in contact with or adhered to the outer circumferential surface of the other side 246b of the metal foil 246. One side 246a and the other side 246b of the metal foil 246 may overlap by a predetermined length L40. One side 246a and the other side 246b of the metal foil 246 may be connected to each other. The metal foil 246 may form a closed loop.

Accordingly, there may be the following advantages over the case in which the metal foil 246 is an open loop. First, it is possible to prevent discharge or sparks that may occur when the induction coil 13 generates an eddy current in the metal foil 246 to heat the metal foil 246. In addition, when the induction coil 13 heats the metal foil 246, it is possible to prevent loss of current. In addition, by reducing the heat generation temperature error of the metal foil 246, the control accuracy is improved, it is possible to maintain the uniformity of the amount or taste of the aerosol.

The end of one side 242a of the first wrapper 242 may be in contact with the end of the other side 246b of the metal foil 246. The outer wrapper 245 may surround the outer circumferential surface of the metal foil 246. One side and the other side of the outer wrapper 245 may be adhered.

The circumference of the tobacco rod 21 may be approximately equal to or similar to a length C obtained by subtracting the length L30 of the overlapping portion from the length L10 of the first wrapper 242. That is, if the radius of the tobacco rod 21 is R (refer to FIG. 7), 2 TR which are the circumferences of the tobacco rod 21 and C, may be approximately the same or similar.

Referring to FIGS. 10 and 12, the metal foil 246 may surround the tobacco rod 21. The metal foil 246 may surround the first wrapper 242 at an inner side of the wrapper 242. That is, as opposed to FIG. 11, the metal foil 246 and the first wrapper 242 may be wrapped so that the metal foil 246 is in contact with the tobacco rod 21.

The outer circumferential surface of one side 242a of the first wrapper 242 may be in contact with or adhered to the inner circumferential surface of the other side 242b of the first wrapper 242. One side 242a and the other side 242b of the first wrapper 242 may overlap by a predetermined length L30.

The outer circumferential surface of one side 246a of the metal foil 246 may be in contact with or adhered to the inner circumferential surface of the other side 246b of the metal foil 246. One side 246a and the other side 246b of the metal foil 246 may overlap by a predetermined length L40. One side 246a and the other side 246b of the metal foil 246 may be connected to each other. The metal foil 246 may form a closed loop.

Accordingly, there may be the following advantages over the case in which the metal foil 246 is an open loop. First, it is possible to prevent discharge or sparks that may occur when the induction coil 13 generates an eddy current in the metal foil 246 to heat the metal foil 246. In addition, when the induction coil 13 heats the metal foil 246, it is possible to prevent loss of current. In addition, by reducing the heat generation temperature error of the metal foil 246, the control accuracy is improved, it is possible to maintain the uniformity of the amount or taste of the aerosol.

The end of one side 242a of the first wrapper 242 may be in contact with the end of the other side 246b of the metal foil 246. The outer wrapper 245 may surround the outer circumferential surface of the metal foil 246. One side and the other side of the outer wrapper 245 may be adhered.

Referring to FIGS. 1 to 12, A cigarette in accordance with one aspect of the present disclosure may include a tobacco rod containing aerosol generating material; a wrapper surrounding the tobacco rod; and a metal foil surrounding the tobacco rod at an inner side or an outer side of the wrapper at a position corresponding to the tobacco rod, wherein opposite ends of the metal foil may be in contact with each other in a circumferential direction to form a closed loop.

In addition, in accordance with another aspect of the present disclosure, wherein a first end of the metal foil may extend past a corresponding first end of the wrapper in the circumferential direction.

In addition, in accordance with another aspect of the present disclosure, wherein the metal foil may be positioned at the outer side of the wrapper, wherein an inner surface of the first end of the wrapper contacts an outer surface of an opposite second end of the wrapper, and wherein an inner surface of the first end of the metal foil contacts an outer surface of an opposite second end of the metal foil.

In addition, in accordance with another aspect of the present disclosure, wherein a second end of the wrapper may extend past a corresponding second end of the metal foil in a direction counter to the circumferential direction.

In addition, in accordance with another aspect of the present disclosure, wherein the metal foil may be positioned at the outer side of the wrapper, wherein an inner surface of the first end of the wrapper may contact an outer surface of the second end of the wrapper opposite the first end, and wherein an inner surface of the first end of the metal foil may contact an outer surface of the second end of the metal foil.

In addition, in accordance with another aspect of the present disclosure, wherein the metal foil may be positioned at the inner side of the wrapper, wherein an outer surface of the first end of the wrapper may contact an inner surface of the second end of the wrapper, wherein an outer surface of the first end of the metal foil may contact an inner surface of the second end of the metal foil.

In addition, in accordance with another aspect of the present disclosure, wherein an end of the wrapper may be in contact with a corresponding end of the metal foil.

In addition, in accordance with another aspect of the present disclosure, further comprises an outer wrapper surrounding the wrapper and the metal foil.

In addition, in accordance with another aspect of the present disclosure, wherein the metal foil and the wrapper may be formed of laminate.

In addition, in accordance with another aspect of the present disclosure, wherein the metal foil may be aluminum.

An aerosol-generating device in accordance with one aspect of the present disclosure may include a body comprising an insertion space configured to accommodate the cigarette; and an induction coil disposed around the insertion space and configured to heat the metal foil.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A cigarette comprising:
a tobacco rod containing aerosol generating material;
a wrapper surrounding the tobacco rod; and
a metal foil surrounding the tobacco rod at an inner side or an outer side of the wrapper at a position corresponding to the tobacco rod,
wherein opposite ends of the metal foil are in contact with each other in a circumferential direction to form a closed loop.

2. The cigarette according to claim 1, wherein a first end of the metal foil extends past a corresponding first end of the wrapper in the circumferential direction.

3. The cigarette according to claim 2,
wherein the metal foil is positioned at the outer side of the wrapper,
wherein an inner surface of the first end of the wrapper contacts an outer surface of an opposite second end of the wrapper, and
wherein an inner surface of the first end of the metal foil contacts an outer surface of an opposite second end of the metal foil.

4. The cigarette according to claim 2, wherein a second end of the wrapper extends past a corresponding second end of the metal foil in a direction counter to the circumferential direction.

5. The cigarette according to claim 4,
wherein the metal foil is positioned at the outer side of the wrapper,
wherein an inner surface of the first end of the wrapper contacts an outer surface of the second end of the wrapper opposite the first end, and
wherein an inner surface of the first end of the metal foil contacts an outer surface of the second end of the metal foil.

6. The cigarette according to claim 4,
wherein the metal foil is positioned at the inner side of the wrapper,
wherein an outer surface of the first end of the wrapper contacts an inner surface of the second end of the wrapper,
wherein an outer surface of the first end of the metal foil contacts an inner surface of the second end of the metal foil.

7. The cigarette according to claim 5, wherein an end of the wrapper is in contact with a corresponding end of the metal foil.

8. The cigarette according to claim 1, further comprising an outer wrapper surrounding the wrapper and the metal foil.

9. The cigarette according to claim 1, wherein the metal foil and the wrapper are formed of laminate.

10. The cigarette according to claim 1, wherein the metal foil is aluminum.

11. An aerosol-generating device comprising:
a body comprising an insertion space configured to accommodate the cigarette of claim 1; and
an induction coil disposed around the insertion space and configured to heat the metal foil.
